(19) United States
(12) Patent Application Publication
(10) Pub. No.: US 2021/0103301 A1
(43) Pub. Date: Apr. 8, 2021

(54) USER ASSISTANCE DRONE DEVICE

(71) Applicant: ROBERT MCCOY, Norcross, GA (US)

(72) Inventor: ROBERT MCCOY, Norcross, GA (US)

(21) Appl. No.: 16/595,561

(22) Filed: Oct. 8, 2019

(51) Int. Cl. G05D 1/12; H04R 1/02; H04R 1/08; G05D 1/10; B64C 39/02; B64D 47/08; B64D 47/02

(52) U.S. Cl. CPC G05D 1/12; H04R 1/025; H04R 1/08; H04N 5/2253; B64C 39/024; B64D 47/08; B64D 47/02; G05D 1/101

(57) ABSTRACT

The user assistance drone device is an unmanned aerial vehicle used as a communication device. The user assistance drone device tracks the client while the user assistance drone device is in the air. The user assistance drone device follows the client and forms an audio communication link between the client and an appropriate authority. The audio communication link allows the client to speak with an appropriate authority. The user assistance drone device comprises the unmanned aerial vehicle and a master circuit. The unmanned aerial vehicle is a device capable of travel through the atmosphere. The master circuit: a) tracks the location and the movement of the client; b) transmits flight instructions to the unmanned aerial vehicle that allows the unmanned aerial vehicle to follow the client; and, c) establishes the audio communication link between the client and the appropriate authority.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of transportation including aerial vehicles, more specifically, an aircraft not otherwise provided for characterized by special use. (B64C39/02)

### SUMMARY OF INVENTION

The user assistance drone device is a communication device. The user assistance drone device is an unmanned aerial vehicle. The user assistance drone device is configured for use with a client. The user assistance drone device tracks the client while the user assistance drone device is in the air. The user assistance drone device follows the client while the user assistance drone device is in the air. The user assistance drone device forms an audio communication link between the client and an appropriate authority. The audio communication link allows the client to speak with the appropriate authority without being in physical contact with the user assistance drone device. The user assistance drone device comprises the unmanned aerial vehicle and a master circuit. The unmanned aerial vehicle is a device capable of travel through the atmosphere. The master circuit: a) tracks the location and the movement of the client; b) transmits flight instructions to the unmanned aerial vehicle that allows the unmanned aerial vehicle to follow the client; and, c) establishes the audio communication link between the client and the appropriate authority.

These together with additional objects, features and advantages of the user assistance drone device will be readily apparent to those of ordinary skill in the art upon reading the following detailed description of the presently preferred, but nonetheless illustrative, embodiments when taken in conjunction with the accompanying drawings.

In this respect, before explaining the current embodiments of the user assistance drone device in detail, it is to be understood that the user assistance drone device is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the user assistance drone device.

It is therefore important that the claims be regarded as including such equivalent construction insofar as they do not depart from the spirit and scope of the user assistance drone device. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a perspective view of an embodiment of the disclosure.

FIG. 2 is a top view of an embodiment of the disclosure.

FIG. 3 is a side view of an embodiment of the disclosure.

FIG. 4 is a bottom view of an embodiment of the disclosure.

FIG. 5 is a rear view of an embodiment of the disclosure.

FIG. 6 is an in-use view of an embodiment of the disclosure.

FIG. 7 is a schematic view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

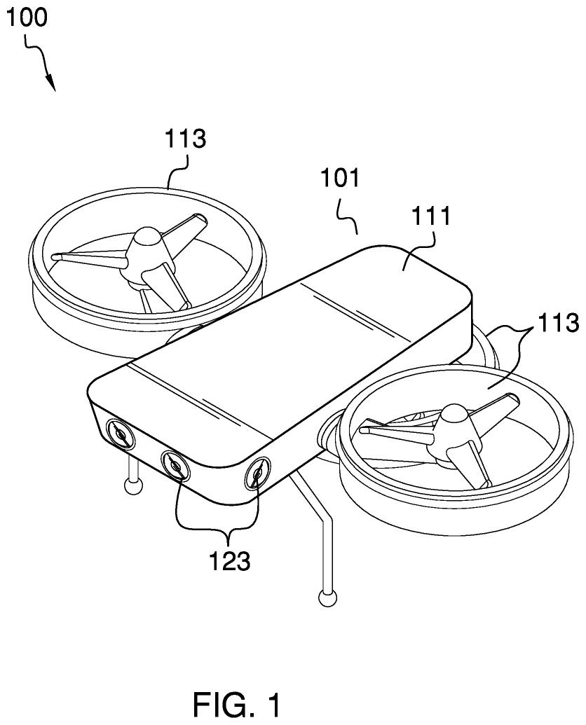

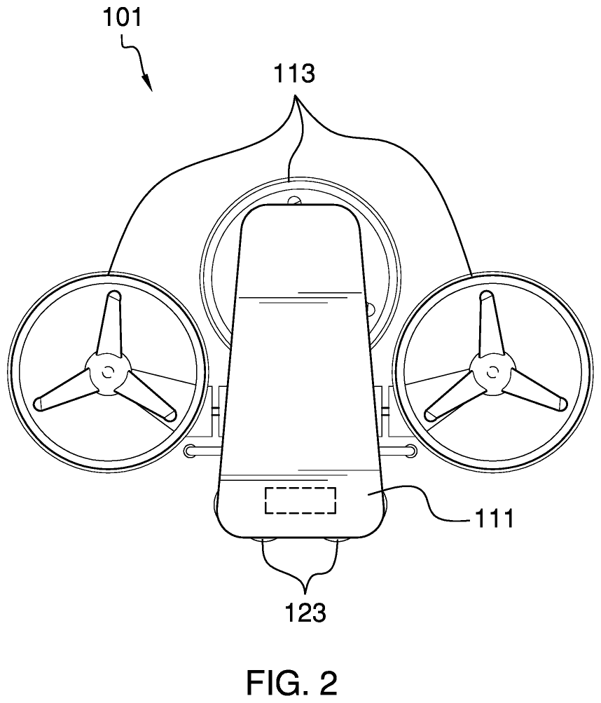

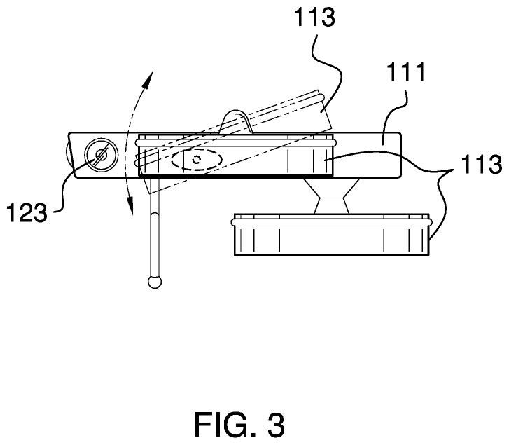

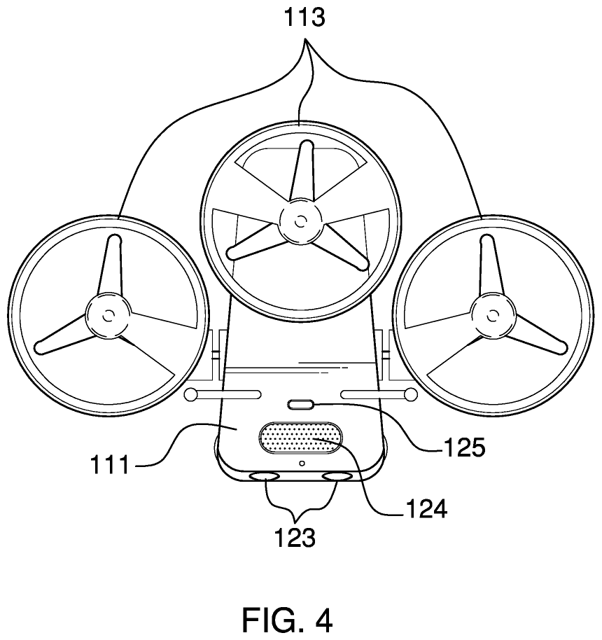

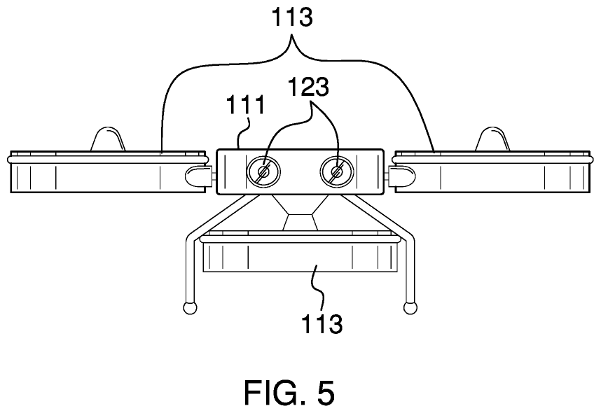

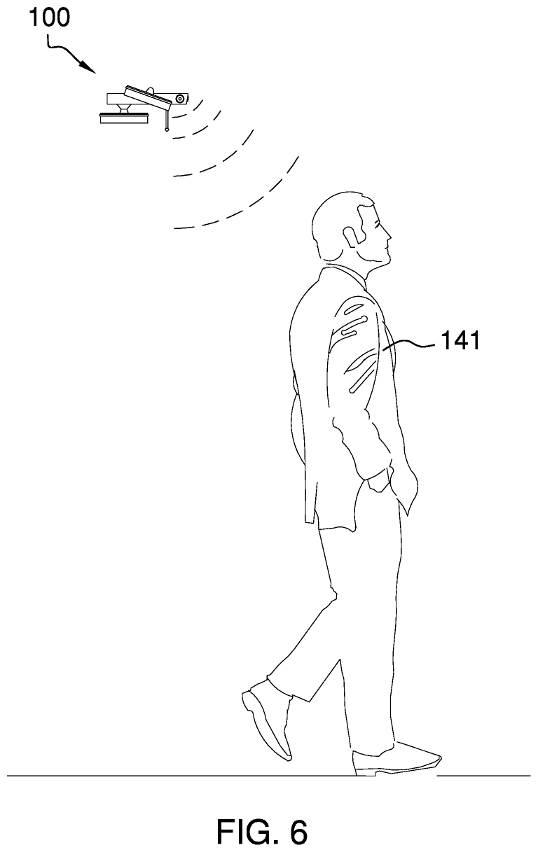

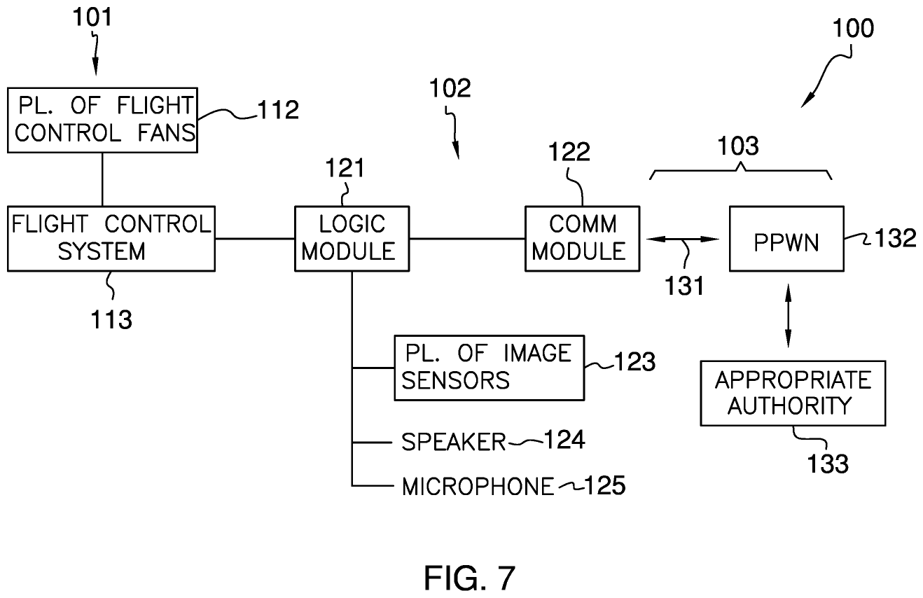

Detailed reference will now be made to one or more potential embodiments of the disclosure, which are illustrated in FIGS. 1 through 7.

The user assistance drone device 100 (hereinafter invention) is a communication device. The invention 100 is an unmanned aerial vehicle 101. The invention 100 is configured for use with a client 141. The invention 100 tracks the client 141 while the invention 100 is in the air. The invention 100 follows the client 141 while the invention 100 is in the air. The invention 100 forms an audio communication link 103 between the client 141 and an appropriate authority 133. The audio communication link 103 allows the client 141 to speak with the appropriate authority 133 without being in physical contact with the invention 100.

The invention 100 comprises the unmanned aerial vehicle 101 and a master circuit 102. The unmanned aerial vehicle 101 is a device capable of travel through the atmosphere. The master circuit 102: a) tracks the location and the movement of the client 141; b) transmits flight instructions to the unmanned aerial vehicle 101 that allows the unmanned aerial vehicle 101 to follow the client 141; and, c) establishes the audio communication link 103 between the client 141 and the appropriate authority 133. The commercially provided and publicly available cellular wireless network 132 is defined elsewhere in this disclosure. The appropriate authority 133 is defined elsewhere in this disclosure. The client 141 is an individual authorized to use the invention 100.

The unmanned aerial vehicle 101 is an aircraft. The unmanned aerial vehicle 101 passes through the atmosphere without forming a load path to a supporting surface. The unmanned aerial vehicle 101 is an automated device. The unmanned aerial vehicle 101 is a robotic device. The unmanned aerial vehicle 101 further houses the master circuit 102. The unmanned aerial vehicle 101 receives navigational information from the master circuit 102 that allows the unmanned aerial vehicle 101 to follow the client 141. The unmanned aerial vehicle 101 comprises a UAV housing 111, a flight control circuit 112, and a plurality of flight control fans 113.

The UAV housing 111 is a rigid structure. The UAV housing 111 contains the master circuit 102 and the flight control circuit 112. The plurality of flight control fans 113 mount on the exterior surfaces of the UAV housing 111. The UAV housing 111 is formed with all apertures and form factors necessary to allow the UAV housing 111 to accommodate the use, the operation, and the external connections of the master circuit 102 and the flight control circuit 112. Methods to form a UAV housing 111 suitable for the purposes described in this disclosure are well-known and documented in the mechanical arts.

The flight control circuit 112 is an electrical circuit. The flight control circuit 112 is a programmable circuit. The flight control circuit 112 is an unsupervised robotic device. The flight control circuit 112 automatically controls the flight management and operation of the unmanned aerial vehicle 101. The flight control circuit 112 receives navigational information from the master circuit 102 such that the flight control circuit 112 can adjust the flight speed and direction of the unmanned aerial vehicle 101 to follow the client 141. Methods to design and fabricate a flight control circuit 112 are well-known and documented in the aviation and electrical arts.

Each of the plurality of flight control fans 113 is a fan structure that generates a flow of air past the unmanned aerial vehicle 101. Each of the plurality of flight control fans 113 provides a portion of the motive forces required to: a) fly the unmanned aerial vehicle 101 through the atmosphere; and, b) navigate the unmanned aerial vehicle 101 through the atmosphere. The orientation of each of the plurality of flight control fans 113 relative to the UAV housing 111 is adjustable.

The flight control circuit 112 individually controls for each flight control fan selected from the plurality of flight control fans 113: a) the volume of air flowing the each selected flight control fan; and, b) the orientation of each selected flight control fan relative to the UAV housing 111. By controlling the air flow through and the orientation relative to the UAV housing 111 of each flight control fan selected from the plurality of flight control fans 113 the flight control circuit 112 can control the elevation, speed, and direction of motion of the unmanned aerial vehicle 101 relative to the client 141.

The master circuit 102 is an electrical circuit. The master circuit 102 tracks the location of the client 141. The master circuit 102 transmits flight instructions to the unmanned aerial vehicle 101 such that the unmanned aerial vehicle 101 is able to follow the client 141. The master circuit 102 establishes the audio communication link 103 between the client 141 and the appropriate authority 133. The master circuit 102 comprises a logic module 121, a communication module 122, a plurality of image sensors 123, a speaker 124, and a microphone 125. The logic module 121, the communication module 122, the plurality of image sensors 123, the speaker 124, and the microphone 125 are electrically interconnected.

The logic module 121 is a programmable electrical circuit. The logic module 121 tracks the location of the client 141. The logic module 121 calculates and transmits flight instructions to the unmanned aerial vehicle 101 such that the unmanned aerial vehicle 101 is able to follow the client 141. The logic module 121 establishes the audio communication link 103 between the client 141 and the appropriate authority 133. The navigational information sent to the flight control circuit 112 by the logic module 121 maintains the unmanned aerial vehicle 101 in a position relative to the client 141 that allows the client 141 to use the speaker 124 and the microphone 125 to communicate with the appropriate authority 133.

The logic module 121 is a readily and commercially available programmable electronic device that is used to manage, regulate, and operate the master circuit 102. Depending on the specific design and the selected components, the logic module 121 can be a separate component within the master circuit 102 or the functions of the logic module 121 can be incorporated into another component within the master circuit 102. The communication module 122 is a wireless electronic communication device that allows the logic module 121 to wirelessly communicate with a commercially provided and publicly available cellular wireless network 132. Specifically, the communication module 122 establishes a wireless communication link 131 between the master circuit 102 and the commercially provided and publicly available cellular wireless network 132.

The communication module 122 establishes the audio communication link 103 between the client 141 and the appropriate authority 133 through the commercially provided and publicly available cellular wireless network 132. The use of a commercially provided and publicly available cellular wireless network 132 is preferred because: a) of its low cost; b) of the widespread availability and the broad interoperability between competing commercially provided and publicly available cellular wireless networks 132; and, c) methods and techniques to establish audio communication link 103 over a commercially provided and publicly available cellular wireless network 132 are well known and documented by those skilled in the electrical arts.

Each of the plurality of image sensors 123 is an image sensor. The image sensor is defined elsewhere in this disclosure. Each of the plurality of image sensors 123 mounts in the UAV housing 111 of the unmanned aerial vehicle 101 such that the field of view of each of the plurality of image sensors 123 monitors the environment around the unmanned aerial vehicle 101. The logic module 121 controls the operation of each of the plurality of image sensors 123. The logic module 121 monitors the electrical signals generated by the plurality of image sensors 123. The logic module 121 uses the plurality of image sensors 123 to determine the location of the client 141 relative to the unmanned aerial vehicle 101 and to calculate and to transmit the navigation data to the flight control circuit 112 that allows the unmanned aerial vehicle 101 to follow the client 141.

The speaker 124 is a transducer. The logic module 121 controls the operation of the speaker 124. The speaker 124 receives electrical signals and converts the electrical signals into audible sounds that can be heard by client 141. The logic module 121 generates the electrical signals received by the speaker 124 based on the data received from the appropriate authority 133 through the audio communication link 103.

The microphone 125 is a transducer. The logic module 121 controls the operation of the microphone 125. The microphone 125 converts received acoustic energy into electrical signals that are transmitted to the logic module 121. The logic module 121 converts and transmits the electrical signals received from the microphone 125 to the appropriate authority 133 using the communication module 122 and the audio communication link 103.

The client 141 communicates with the appropriate authority 133 using the speaker 124 and the microphone 125.

The audio communication link 103 is a data exchange structure used to transfer data in the form of audible sounds: a) from the client 141 to the appropriate authority 133; and, b) from the appropriate authority 133 to the client 141. The audio communication link 103 formed between the client 141 and the appropriate authority 133 is formed using the wireless communication link 131 and the commercially provided and publicly available cellular wireless network 132.

The following definitions were used in this disclosure:

Appropriate Authority: As used in this disclosure, an appropriate authority is a previously determined person or organization that is designated to send and receive alarm or other notification messages regarding a monitored system or activity.

Atmosphere: As used in this disclosure, the atmosphere refers to a blanket of gases (primarily nitrogen and oxygen) that surround the earth. Typical atmospheric conditions are approximated and characterized as the normal temperature and pressure. Atmospheric gases are commonly called air.

Automatic: As used in this disclosure, automatic refers to a device, process, or a system that operates without human control, supervision or participation in the operation of the device, process, or system. The verb form of automatic is to automate.

Blade: As used in this disclosure, a blade is a term that is used to describe a wide and flat structure or portion of a larger structure such as a propeller.

Camera: As used in this disclosure, a camera is a sensor that converts light into electric signals that encode and records the spatial orientation of the captured light in a manner that reproduces the images seen by a human eye.

Client: As used in this disclosure, a client is an individual who is designated to receive the services of the disclosure at bar.

Commercially Provided And Publicly Available Cellular Wireless Network: As used in this disclosure, a commercially provided and publicly available cellular wireless network refers to subscription based publically available wireless network commonly used to provide wireless communication access for personal data devices. The commercially provided and publicly available cellular wireless network will typically provide voice communication, data communication services, and SMS and MMS messaging services. The commercially provided and publicly available cellular wireless network is commonly referred to as the cellular network. The commercially provided and publicly available cellular wireless network is abbreviated as the PPWN.

Communication Link: As used in this disclosure, a communication link refers to the structured exchange of data between two objects.

Fan: As used in this disclosure, a fan is a pump that moves a gas. The first potential embodiment of this disclosure assumes that the fan is a mechanical device with rotating blades that is used to create a flow or current of a gas.

Field of View: As used in this disclosure, a field of view refers to one or more angles which delimits an area from which electromagnetic radiation will be sensed by a person or an image sensor.

Form Factor: As used in this disclosure, the term form factor refers to the size and shape of an object.

Housing: As used in this disclosure, a housing is a rigid structure that encloses and protects one or more devices.

Image Sensor: As used in this disclosure, an image sensor receives light from the exterior of the image sensor and converts the received light into a digital representation of sufficient detail to allow a logic module to create and display a visual reproduction of the source of the captured light.

Load: As used in this disclosure, the term load refers to an object upon which a force is acting or which is otherwise absorbing energy in some fashion. Examples of a load in this sense include, but are not limited to, a mass that is being moved a distance or an electrical circuit element that draws energy. The term load is also commonly used to refer to the forces that are applied to a stationary structure.

Load Path: As used in this disclosure, a load path refers to a chain of one or more structures that transfers a load generated by a raised structure or object to a foundation, supporting surface, or the earth.

Logic Module: As used in this disclosure, a logic module is a readily and commercially available electrical device that accepts digital and analog inputs, processes the digital and analog inputs according to previously specified logical processes and provides the results of these previously specified logical processes as digital or analog outputs. The disclosure allows, but does not assume, that the logic module is programmable.

Microphone: As used in this disclosure, a microphone is a transducer that converts the energy from vibration into electrical energy. The sources of vibrations include, but are not limited to, acoustic energy.

PPWN: As used in this disclosure, the PPWN is an acronym for a publically provided wireless network. The PPWN refers to a commercially provided and publicly available cellular wireless network.

Robot: As used in this disclosure, a robot is a programmable electronic device that automatically performs a series of predetermined actions.

Speaker: As used in this disclosure, a speaker is an electrical transducer that converts an electrical signal into an audible sound.

Speech Recognition: As used in this disclosure, an speech recognition refers to a collection of commercially available algorithms that capture process a digital representation of an audible sound in a manner that allows an electronically operated device, such as a computer, to extract data from the digital representation of an audible sound and take a subsequent action based on the data extracted from the audible sound.

Supervisory: As used in this disclosure, supervisory describes a relationship between a first object and a second object wherein the function of the first object is limited to initiating and monitoring the actions or activity of the second object. The first object is said to supervise the second object.

Supporting Surface: As used in this disclosure, a supporting surface is a horizontal surface upon which an object is placed and to which the load path of the object is transferred. This disclosure assumes that an object placed on the supporting surface is in an orientation that is appropriate for the normal or anticipated use of the object.

Transducer: As used in this disclosure, a transducer is a device that converts a physical quantity, such as pressure or brightness into an electrical signal or a device that converts an electrical signal into a physical quantity.

Unmanned Aerial Vehicle: As used in this disclosure, an unmanned aerial vehicle refers to a flying vehicle that is controlled remotely or automatically. By flying is meant that the unmanned aerial vehicle travels through the atmosphere without requiring the physical formation of a load path between the unmanned aerial vehicle and a supporting surface. By definition, an unmanned aerial vehicle does not transport a person. A common abbreviation for unmanned aerial vehicle is UAV. The UAV is commonly referred to as a drone.

Unsupervised: As used in this disclosure, unsupervised refers to an object or device that operates without supervision.

Wireless: As used in this disclosure, wireless is an adjective that is used to describe a communication channel between two devices that does not require the use of physical cabling.

With respect to the above description, it is to be realized that the optimum dimensional relationship for the various components of the invention described above and in FIGS. 1 through 7 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. The user assistance drone device comprising
an unmanned aerial vehicle and a master circuit;
wherein the unmanned aerial vehicle houses the master circuit;
wherein the user assistance drone device is a communication device;
wherein the user assistance drone device is an unmanned aerial vehicle;
wherein the user assistance drone device is adapted for use with a client;
wherein the user assistance drone device tracks the client while the user assistance drone device is in the air;
wherein the user assistance drone device follows the client while the user assistance drone device is in the air;
wherein the user assistance drone device forms an audio communication link between the client and an appropriate authority;
wherein the unmanned aerial vehicle is a device capable of travel through the atmosphere.

2. The user assistance drone device according to claim 1
wherein the unmanned aerial vehicle is an aircraft;
wherein the unmanned aerial vehicle passes through the atmosphere without forming a load path to a supporting surface.

3. The user assistance drone device according to claim 2
wherein the master circuit tracks the location and the movement of the client;
wherein the unmanned aerial vehicle receives navigational information from the master circuit.

4. The user assistance drone device according to claim 3
wherein the unmanned aerial vehicle is an automated device;
wherein the unmanned aerial vehicle is a robotic device.

5. The user assistance drone device according to claim 4
wherein the master circuit is an electrical circuit;
wherein the master circuit tracks the location of the client;
wherein the master circuit transmits flight instructions to the unmanned aerial vehicle such that the unmanned aerial vehicle is able to follow
wherein the master circuit establishes the audio communication link between the client and the appropriate authority.

6. The user assistance drone device according to claim 5 wherein the audio communication link is a data exchange structure used to transfer data in the form of audible sounds: a) from the client to the appropriate authority; and, b) from the appropriate authority to the client.

7. The user assistance drone device according to claim 6
wherein the unmanned aerial vehicle comprises a UAV housing, a flight control circuit, and a plurality of flight control fans;
wherein the UAV housing contains the master circuit and the flight control circuit;
wherein the plurality of flight control fans mount on the exterior surfaces of the UAV housing.

8. The user assistance drone device according to claim 7
wherein the master circuit comprises a logic module, a communication module, a plurality of image sensors, a speaker, and a microphone;
wherein the logic module, the communication module, the plurality of image sensors, the speaker, and the microphone are electrically interconnected.

9. The user assistance drone device according to claim 8 wherein the UAV housing is a rigid structure.

10. The user assistance drone device according to claim 9
wherein the flight control circuit is an electrical circuit;
wherein the flight control circuit is a programmable circuit;
wherein the flight control circuit is an unsupervised robotic device;
wherein the flight control circuit automatically controls the flight management and operation of the unmanned aerial vehicle;
wherein the flight control circuit receives navigational information from the master circuit such that the flight control circuit can adjust the flight speed and direction of the unmanned aerial vehicle to follow the client.

11. The user assistance drone device according to claim 10
wherein each of the plurality of flight control fans is a fan structure that generates a flow of air past the unmanned aerial vehicle;
wherein each of the plurality of flight control fans provides a portion of the motive forces required to:
a) fly the unmanned aerial vehicle through the atmosphere; and, b) navigate the unmanned aerial vehicle through the atmosphere.

12. The user assistance drone device according to claim 11 wherein the orientation of each of the plurality of flight control fans relative to the UAV housing is adjustable.

13. The user assistance drone device according to claim 12
wherein the flight control circuit individually controls for each flight control fan selected from the plurality of flight control fans: a) the volume of air flowing the each selected flight control fan; and, b) the orientation of each selected flight control fan relative to the UAV housing;
wherein by controlling the air flow through and the orientation relative to the UAV housing of each flight control fan selected from the plurality of flight control fans the flight control circuit controls the elevation, speed, and direction of motion of the unmanned aerial vehicle relative to the client.

14. The user assistance drone device according to claim 13
wherein the logic module is a programmable electrical circuit;
wherein the logic module tracks the location of the client;
wherein the logic module calculates and transmits flight instructions to the unmanned aerial vehicle such that the unmanned aerial vehicle is able to follow the client.

15. The user assistance drone device according to claim 14
wherein the logic module establishes the audio communication link between the client and the appropriate authority;
wherein the navigational information sent to the flight control circuit by the logic module maintains the unmanned aerial vehicle in a position relative to the client that allows the client to use the speaker and the microphone to communicate with the appropriate authority.

16. The user assistance drone device according to claim 15
wherein the communication module is a wireless electronic communication device that allows the logic module to wirelessly communicate with a commercially provided and publicly available cellular wireless network;
wherein the communication module establishes a wireless communication link between the master circuit and the commercially provided and publicly available cellular wireless network.

17. The user assistance drone device according to claim 16
wherein the communication module establishes the audio communication link between the client and the appropriate authority through the commercially provided and publicly available cellular wireless network;
wherein the audio communication link formed between the client and the appropriate authority is formed using the wireless communication link and the commercially provided and publicly available cellular wireless network.

18. The user assistance drone device according to claim 17
wherein each of the plurality of image sensors is an image sensor;
wherein each of the plurality of image sensors mounts in the UAV housing of the unmanned aerial vehicle such that the field of view of each of the plurality of image sensors monitors the environment around the unmanned aerial vehicle;
wherein the logic module controls the operation of each of the plurality of image sensors;
wherein the logic module monitors the electrical signals generated by the plurality of image sensors;
wherein the logic module uses the plurality of image sensors to determine the location of the client relative to the unmanned aerial vehicle and to calculate and to transmit the navigation data to the flight control circuit that allows the unmanned aerial vehicle to follow the client.

19. The user assistance drone device according to claim 18
wherein the speaker is a transducer;
wherein the logic module controls the operation of the speaker;
wherein the speaker receives electrical signals and converts the electrical signals into audible sounds heard by the client;
wherein the logic module generates the electrical signals received by the speaker based on the data received from the appropriate authority through the audio communication link.

20. The user assistance drone device according to claim 19
wherein the microphone is a transducer;
wherein the logic module controls the operation of the microphone;
wherein the microphone converts received acoustic energy into electrical signals that are transmitted to the logic module;
wherein the logic module converts and transmits the electrical signals received from the microphone to the appropriate authority using the communication module and the audio communication link;
wherein the client communicates with the appropriate authority using the speaker and the microphone.
